(19) United States
(12) Patent Application Publication
(10) Pub. No.: US 2010/0185952 A1
(43) Pub. Date: Jul. 22, 2010

(54) PORTLET PALETTE WITH AUTOMATIC REMOTE PORTLET INTEGRATION

(75) Inventors: Daniel Blum, Stuttgart (DE); Jan Paul Buchwald, Boeblingen (DE); Richard Jacob, Ostfildern (DE); Timo Kussmaul, Boeblingen (DE); Oliver Then, Aidlingen (DE)

Correspondence Address: CANTOR COLBURN LLP - IBM TUSCON DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/355,830

(22) Filed: Jan. 19, 2009

(51) Int. Cl. G06F 3/00

(52) U.S. Cl. 715/738

(57) ABSTRACT

A method for integrating remote portlets into a consumer portal that includes providing a list of remote portlet producers to a portlet palette within the consumer portal, automatically obtaining available remote portlets, via the portlet palette, using the provided list, storing information corresponding to the available remote portlets, in the portlet palette, merging information regarding local portlets and the available remote portlets to form an available portlet list on the portlet palette, allowing a user to view the available portlet list, receiving a selected available remote portlet from the available portlet list as selected by the user and performing a drag and drop operation of the selected remote portlet to a portal page on the consumer portal, and automatically creating a producer reference corresponding to a respective remote portlet producer associated with the selected remote portlet and a remote portlet reference corresponding to the selected remote portlet on the consumer portal.

### BACKGROUND

The present invention relates to a web services for remote portlets (WSRP) system and more specifically, to a WSRP system and method for automatic integration of remote portlets.

Typically, in a conventional WSRP system, a portal administrator registers producers via a consumer portal using the URL address of the respective producers and a WSRP consumer within the consumer portal selects and consumes desired remote portlets from the respective producer upon registering. Then, the portal administrator places the remote portlets on a portal page within the consumer portal. FIG. 1 illustrates a conventional WSRP system 10, which includes a plurality of WSRP producers 11, a consumer portal 16 and a client 20. The WSRP producer 11 provides remote portlets (i.e., applications) to a WSRP consumer 13 of the consumer portal 16. A portal administrator registers the respective WSRP producer 11 in the consumer portal 16. The WSRP consumer 13 consumes the portlet received from the respective WSRP producer 11 after the WSRP producer 11 has been registered by the portal administrator. In a conventional method, the WSRP consumer 13 selects a respective WSRP producer 11 and chooses a portlet from the respective WSRP producer 11 to be consumed, and consumes the portlet. The portal administrator then places the consumed remote portlets 14 received, on a portal page 15 of the consumer portal 16. The portal page 15 is displayed via a browser on the client side 20.

FIG. 2 illustrates an operation of consuming a remote portlet from a WSRP producer via a conventional WSRP system (as indicated by the arrows shown). In FIG. 2, the portal administrator in the WSRP consumer 13 of the consumer portal 16 is required to obtain a URL address of a WSRP producer 11 to be registered. The WSRP producer 11 is provided by a WSRP content provider 12. The portal administrator creates a producer reference 22 using the URL address of the WSRP producer 11, for example, on the WSRP consumer 13 and the WSRP producer 11 becomes known to the WSRP consumer 13. Upon creating the producer reference 22, the WSRP consumer 11 requests a list of available portlets from the WSRP producer 11. The WSRP producer 11 then sends a list of available portlets to the WSRP consumer 13. The portal administrator then selects a remote portlet from the list, to be integrated on the consumer portal 16 and a reference object (i.e., a remote portlet reference 24) to the remote portlet to be integrated is created on the WSRP consumer 13. The remote portlet reference 24 includes information corresponding to a respective producer 11 and a unique ID (i.e., a portlet handle) to identify the provided portlet 11a on the producer 11 side. The portal administrator then creates a portal page 15 and places the consumed portlets 14 on the portal page 14. The communication between the WSRP consumer 12 and the WSRP producer 10 is performed using the producer reference 22 and the remote portlet reference 24. A portlet palette, which is a graphical representation of a list of portlets, is employed so that a user can add the consumed portlets 14 to the portal page 15 through a drag and drop process.

There are several problems associated with the conventional method. For example, many manual steps are required by the portal administrator in order to integrate a remote portlet on the WSRP consumer 13 (as shown in FIGS. 1 and 2). Further, there is no overview provided to display all available remote portlets and since the portal administrator is required to obtain the URL address for each producer, if many producers having different portlets are required, the conventional method may be very time-consuming and inefficient since the administrator has to select each producer individually and check for available remote portlets of this producer. Further, the conventional WSRP system does not automatically modify the portlet palette and the portlet palette does not provide a list of available remote portlets.

### SUMMARY

The present invention provides a WSRP system and method for automatic integration of remote portlets within a consumer portal by employing an integration module and automatically providing a list of available remote portlets to the portal administrator.

According to an embodiment of the present invention, a method for integrating remote portlets into a consumer portal is provided. The method includes providing a list of remote portlet producers, to a portlet palette within the consumer portal, automatically obtaining available remote portlets, via the portlet palette, using the provided list, storing information corresponding to the available remote portlets, in the portlet palette, merging information regarding local portlets and the available remote portlets to form an available portlet list on the portlet palette, allowing a user to view the available portlet list, receiving a selected available remote portlet from the available portlet list as selected by the user and performing a drag and drop operation of the selected remote portlet to a portal page on the consumer portal, and automatically creating a producer reference corresponding to a respective remote portlet producer associated with the selected remote portlet and a remote portlet reference corresponding to the selected remote portlet on the consumer portal.

According to another embodiment of the present invention, a WSRP system is provided implementing the above-mentioned method.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is block diagram illustrating a conventional WSRP system.

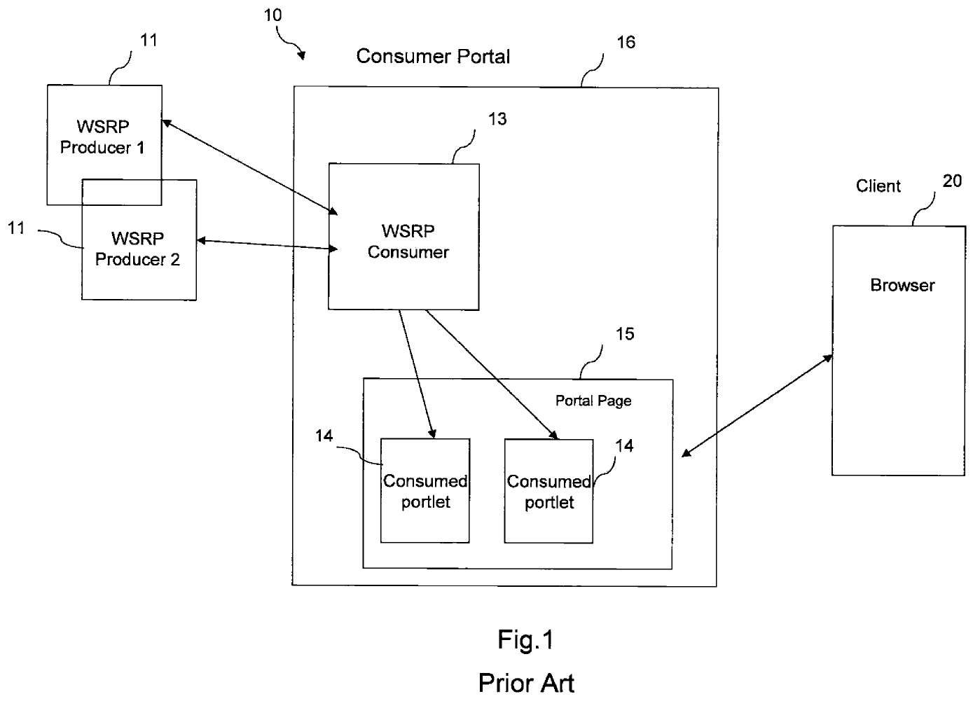

FIG. 2 is a block diagram illustrating an operation of consuming a remote portlet from a WSRP producer within a conventional WSRP system.

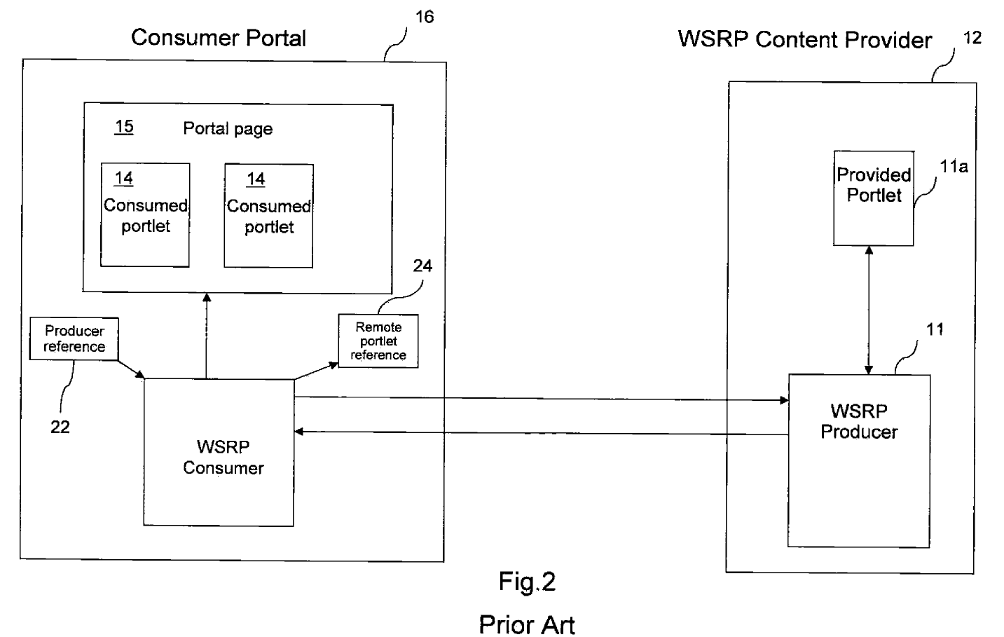

FIG. 3 is a block diagram illustrating a WSRP system that can be implemented within embodiments of the present invention.

FIG. 4 is a block diagram illustrating the integration module shown in FIG. 3 that can be implemented within embodiments of the present invention.

FIG. 5 is a flowchart illustrating a method for integrating remote portlets within the WSRP system that can be implemented within embodiments of the present invention.

### DETAILED DESCRIPTION

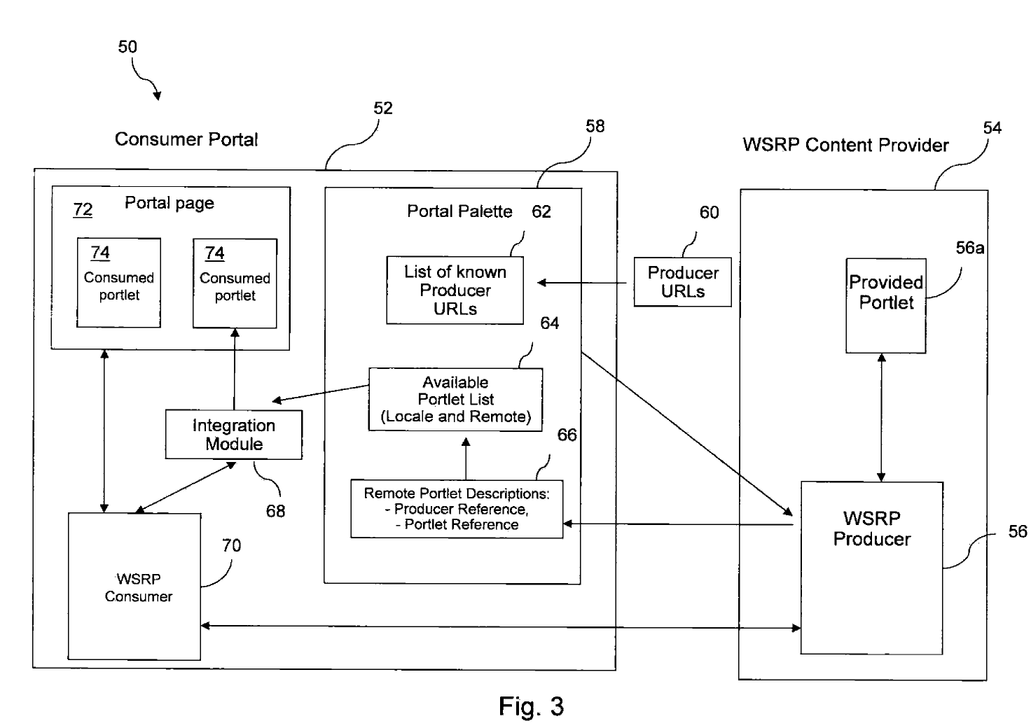

With reference now to FIG. 3, there is a WSRP system 50 provided according to an embodiment of the present invention. The WSRP system 50 includes a consumer portal 52, and a WSRP content provider 54 including a WSRP Producer 56. For the purpose of illustration only, one WSRP content provider 54 is shown; however, the present invention is not limited to a particular number of WSRP content providers 54 and may vary as necessary. The consumer portal 52 further includes a portlet palette 58, an integration module 68, a WSRP consumer 70 and at least one portal page 72. According to an embodiment of the present invention, the WSRP consumer 70 may connect to multiple WSRP Producers running on different WSRP Content Provider systems.

A description of a method for integrating remote portlets within the WSRP system 50 will now be described below while referencing FIGS. 3 through 5.

According to an embodiment of the present invention, the automatic integration of remote portlets is performed as follows:

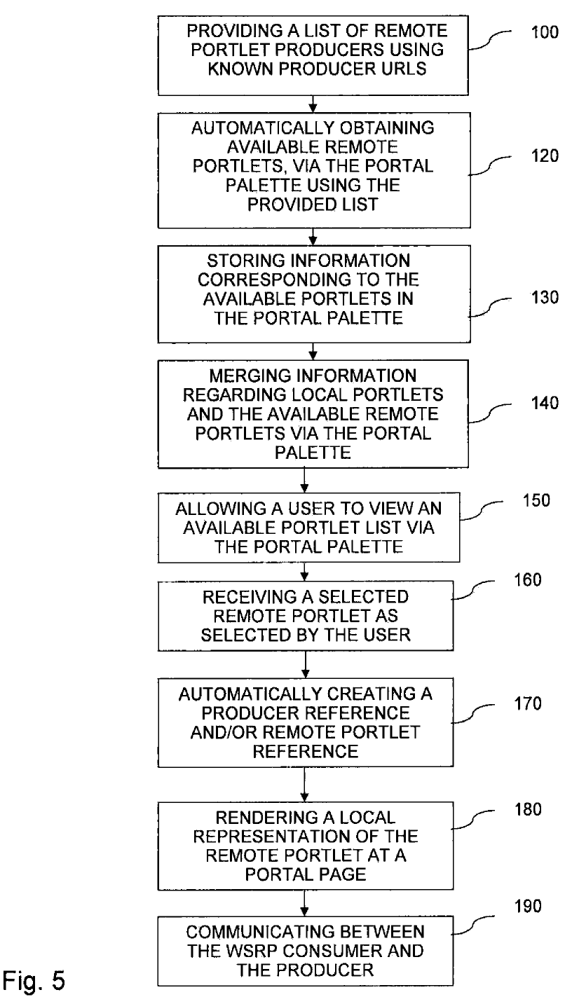

As shown in FIG. 3, a portal administrator or a user creates a list 62 of references to multiple WSRP producers 56 and the list may be in configuration files, for example, URL addresses 60 of the producers 56 (operation 100 in FIG. 5). The producer URL addresses 60 may originate from user input, properties files, or may result from automated crawling sources like registries and websites, for example. The portlet palette 58 then includes the list 62 of known producer URL addresses 60, for example. The portlet palette 58 uses the producer URL addresses 60 on the provided list 62 to automatically obtain available remote portlets using a WSRP protocol from the producer(s) 56 (operation 120 in FIG. 5). The WSRP producer 56 returns an available list of remote portlets to the portlet palette 58. The list includes parameters associated with each portlet such as portlet name and description, for example. The portlet palette 58 stores information 66 corresponding to the available remote portlets (operation 130 in FIG. 5). According to an embodiment of the present invention, the stored information includes at least one of the portlet name, a description of the remote portlet, an associated producer reference and an associated remote portlet reference, for example. According to an embodiment of the present invention, since the portlet palette 58 stores references to several producers 56, the portlet palette 58 may connect to those producers 56 and make a request for all available portlets and then shows all available portlets from all the producers 56, in the portlet palette 58.

The portlet palette 58 merges information regarding local portlets and the stored information regarding available remote portlets to form an available portlet list 64 (operation 140 in FIG. 5). According to an embodiment of the present invention, the available remote portlets may be filtered or grouped prior to forming the available portlet list 64, based on the stored information 66. For example, if there are many producers 56 each having several portlets, the portal administrator may want to only display portlets related to a specific topic such as banking applications or flight applications, for example.

The portal administrator views the available portlet list 64 as filtered or grouped if desired, and selects and drags a selected remote portlet 56a to be consumed from the list 64 and drops the consumed portlet 74 on a portal page 72 (operations 150 and 160 in FIG. 5).

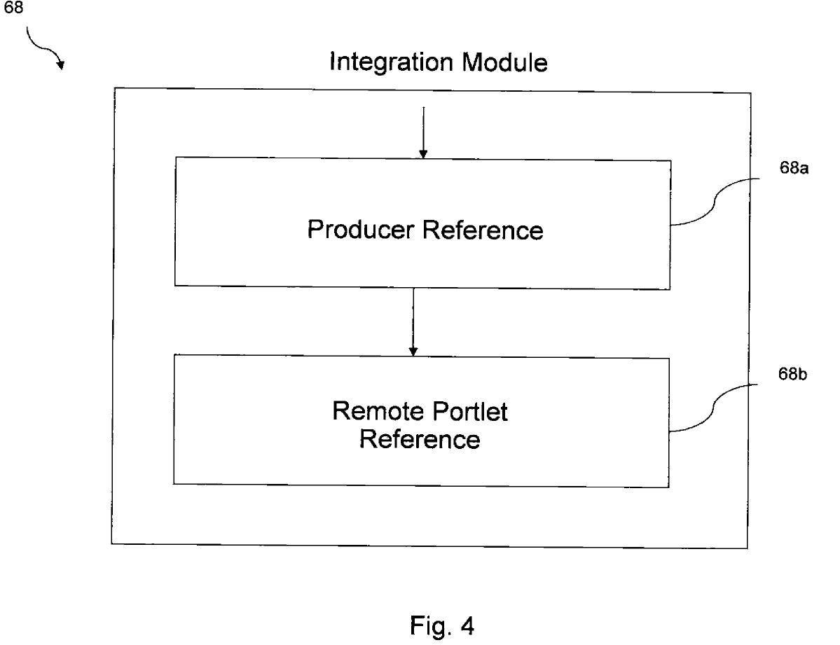

Since the remote portlets are not available locally on the local consumer portal 52, a producer reference and a remote portlet reference associated with the remote portlet may need to be created via the integration module 68 according to an embodiment of the present invention (operation 170 in FIG. 5). Details of the integration module 68 will now be discussed with reference to FIGS. 3 and 4. The integration module 68 automatically creates a producer reference 68a and/or a remote portlet reference 68b for the consumed portlet 74 on the consumer side, when needed. First, the integration module 68 determines whether there is already a producer reference 68a available for the selected remote portlet 56a on the WSRP consumer 70. If it is determined that there is already a producer reference 68a created, then a new producer reference is not created. If it is determined that a producer reference 68a is not already available, then the integration module 68 automatically creates a new producer reference 68a corresponding to the selected remote portlet 56a provided, on the WSRP consumer 70. Next, the integration module 68 determines whether there is a remote portlet reference 68b available for the selected remote portlet 56a. If the selected remote portlet 56a was previously integrated then there may already be a remote portlet reference 68b available. In this case, the integration module 68 will not create a new remote portlet reference 68b. However, if the selected remote portlet 56a was not previously integrated, then the integration module 68 automatically creates a new remote portlet reference 68b on the WSRP consumer 70. Once the producer reference 68a and the remote portlet reference 68b are created, a local representation of the selected remote portlet 56a is rendered at the portal page 72 (operation 180 in FIG. 5).

According to an embodiment of the present invention, the WSRP consumer 70 may then communicate with the WSRP producer 56 to obtain portlet information such as portlet markup, as needed (operation 190 in FIG. 5).

The WSRP system and method according to embodiments of the present invention provide an efficient way for integrating remote portlets within a consumer portal by including an integration module that automatically creates the producer reference and the remote portlet reference within the consumer portal. Also, by listing all available local and remote portlets together in the portlet palette. Further, the producer and remote portlet references are created by demand only, when the remote portlet is integrated.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one ore more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A method for integrating remote portlets into a consumer portal, the method comprising:
providing a list of remote portlet producers to a portlet palette within the consumer portal;
automatically obtaining available remote portlets, via the portlet palette, using the provided list;
storing information corresponding to the available remote portlets, in the portlet palette;
merging information regarding local portlets and the available remote portlets to form an available portlet list on the portlet palette;
allowing a user to view the available portlet list;
receiving a selected available remote portlet from the available portlet list as selected by the user and performing a drag and drop operation of the selected remote portlet to a portal page on the consumer portal; and
automatically creating a producer reference corresponding to a respective remote portlet producer associated with the selected remote portlet and a remote portlet reference corresponding to the selected remote portlet on the consumer portal.

2. The method of claim 1, wherein the provided list of remote portlet producers includes URL addresses corresponding to each remote portlet producer.

3. The method of claim 2, wherein the information corresponding to the available remote portlets includes at least one of a portlet name, a description, an associated producer reference and an associated remote portlet reference.

4. The method of claim 3, further comprising:
filtering or grouping the available remote portlets prior to forming the available portlet list, based on the stored information.

5. The method of claim 3, wherein automatically creating a producer reference and a remote portlet reference comprises:
determining whether a producer reference for the selected remote portlet has been created and automatically creating a producer reference when it is determined that a producer reference has not been created; and
determining whether a remote portlet reference for the selected remote portlet has been created, and automatically creating a remote portlet reference when it is determined that a remote portlet reference has not been created.
